(19) United States
(12) Patent Application Publication
(10) Pub. No.: US 2005/0233921 A1
(43) Pub. Date: Oct. 20, 2005

(54) Cleaning solution for photoresist, method for forming a photoresist pattern using the same, and semiconductor device

(75) Inventors: Geun Su Lee, Gyeonggi-do (KR); Seung Chan Moon, Gyeonggi-do (KR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: HYNIX SEMICONDUCTOR INC., Gyeonggi-do (KR)

(21) Appl. No.: 10/999,280

(22) Filed: Nov. 30, 2004

(30) Foreign Application Priority Data
Apr. 19, 2004 (KR) KR10-2004-0026686

(51) Int. Cl. C11D 1/00

(52) U.S. Cl. 510/175

(57) ABSTRACT

A cleaning solution for photoresist used to clean a semiconductor substrate in the final process after a developing step for formation of photoresist patterns, and a method for forming a photoresist pattern using the same. The cleaning solution for photoresist comprising a compound of Formula 1, an optional alcohol compound and water has a lower surface tension than that of distilled water used as a conventional cleaning solution. Therefore, when the disclosed cleaning solution is used to wash a semiconductor substrate in the final process after the developing step for formation of photoresist patterns, pattern collapse can remarkably be decreased.
R{(OCH₂CH₂)ₗ[O(CH₂)ₘCH₂]ₙ}R′ Formula 1 wherein
R and R′ are independently H, C₁-C₄₀ alkyl or C₁-C₄₀ alkyl aryl; l and n are independently integers ranging from 1 to 500; m is an integer ranging from 0 to 10; and the weight average molecular weight ranges from 100 to 50,000.

### BACKGROUND OF THE DISCLOSURE

1. Technical Field

The disclosure relates to cleaning solutions for photoresist, methods for forming a photoresist pattern using the same, and semiconductor device fabricated thereby. More specifically, the disclosure relates to a cleaning solution for photoresist for cleaning a semiconductor substrate after developing step during photoresist pattern formation, improving pattern profile and preventing pattern collapse.

2. Description of the Related Art

As device miniaturization has accelerated, the wavelength of the light source for exposure during fabrication becomes shorter. In order to form ultrafine photoresist patterns less than 100 nm in size, the light source tends to change from KrF(248 nm) to ArF(193 nm), and photoresist compositions are under development corresponding to the change of light source. However, the kinds of photoresist for ArF light source have been remarkably limited. Actually, since the hydrophobic property of ArF photoresist compositions has dramatically increased, the photoresist composition does not homogeneously interact with aqueous developing solutions, cleaning solutions or water. As a result, the surface of a photosensitizer becomes rough and critical dimension (CD) also tends to change, resulting in the inhibition of stability of the overall process. In addition, as devices become more microscopic, an aspect ratio of photoresist patterns (which refers to thickness of photoresist, that is, ratio of pattern height/pattern width) becomes higher, resulting in pattern collapse during the cleaning procedure.

Pattern collapse occurs because capillary force exceeds the elastic force of the photoresist when the height of the photoresist pattern exceeds a threshold value. In order to solve this problem, several methods have been used, which include methods for increasing internal elastic force of the photoresist, decreasing surface tension of the photoresist, or increasing adhesive force between an underlying layer and the photoresist.

Meanwhile, the general method for forming a photoresist pattern on a semiconductor substrate includes the following steps: First, an underlying layer is formed on a semiconductor substrate. Then, a photoresist film is formed on the underlying layer. After exposing and developing the photoresist film, photoresist pattern is formed. Herein, when a positive photoresist film is used, the photoresist film in the exposed region is removed by a developing solution, thereby obtaining a positive-type photoresist pattern.

After the photoresist pattern is formed, distilled water is sprayed from an upper portion of a spin device while the semiconductor substrate is spinning to wash the semiconductor substrate. During this step, the pattern can collapse due to the high surface tension of the distilled water.

So, in order to prevent pattern collapse during the development process in the formation of ultrafine photoresist patterns of less than 130 nm, the disclosure provides a cleaning solution having lower surface tension than distilled water conventionally used as a cleaning solution in the pattern formation process.

### SUMMARY OF THE DISCLOSURE

Accordingly, disclosed herein is a cleaning solution for photoresist preventing photoresist pattern collapse.

Also, disclosed herein is a method for forming a photoresist pattern using the disclosed cleaning solution for photoresist, and there is provided a semiconductor device obtained by using the above-described method.

### BRIEF DESCRIPTION OF THE DRAWINGS

FIG. 1 is a photograph showing a photoresist pattern obtained from the result of Example 5.

FIG. 2 is a photograph showing a photoresist pattern obtained from the result of Example 6.

FIG. 3 is a photograph showing a photoresist pattern obtained from the result of Example 7.

FIG. 4 is a photograph showing a photoresist pattern obtained from the result of Example 8.

FIG. 5 is a photograph showing a photoresist pattern obtained from the result of Comparative Example.

### DETAILED DESCRIPTION OF PREFERRED EMBODIMENTS

There is provided a cleaning solution for photoresist comprising water as a main component and a surfactant represented by Formula 1 as an additive:
R{(OCH₂CH₂)ₗ[O(CH₂)ₘCH₂]ₙ}R′ Formula 1
wherein
R and R′ are independently H, C₁-C₄₀ alkyl or C₁-C₄₀ alkylaryl;
l and n are independently integers ranging from 1 to 500;
m is an integer ranging from 0 to 10; and
the weight average molecular weight ranges from 100 to 50,000.

In the compound of Formula 1, R and R′ can independently be selected from the group consisting of H, methyl, ethyl, propyl, butyl, pentyl, hexyl, heptyl, octyl, octylphenyl, nonyl, nonylphenyl, decyl, decylphenyl, undecyl, undecylphenyl, lauryl, laurylphenyl, tridecyl, and tridecylphenyl. One and n can each preferably be an integer ranging from 10 to 50.

As preferred examples, the compound of Formula 1 can be a compound listed below: a compound wherein m is 1, R is nonyl, R′ is H and the weight average molecular weight is 2,000; a compound wherein m is 2, R is lauryl, R′ is H and the weight average molecular weight is 2,000; a compound wherein m is 1, R is octyl, R′ is H and the weight average molecular weight is 3,000; a compound wherein m is 2, R is lauryl, R′ is H and the weight average molecular weight is 2,000; a compound wherein m is 1, R is nonylphenyl, R′ is H and the weight average molecular weight is 3,000; a compound wherein m is 2, R is lauryl, R′ is H and the weight average molecular weight is 2,000; a compound wherein m is 3, R is lauryl, R′ is H and the weight average molecular weight is 2,000; a compound wherein m is 1, R is H, R′ is H and the weight average molecular weight is 10,000; a compound wherein m is 1, R is tridecyl, R′ is H and the weight average molecular weight is 3,000; and a compound wherein m is 3, R is lauryl, R′ is H and the weight average molecular weight is 2,000.

The above-described compound of Formula 1 may be used as a surfactant singly or in combination of two or more compounds to acquire a synergistic effect.

A derivative of the compound represented by Formula 1 used as a surfactant in the disclosed cleaning solution is easily dissolved in water, and it helps homogeneous interaction with aqueous solution. Therefore, it results in improvement of pattern profiles, line edge roughness (abbreviated as “LER”) and uniformity. Additionally, the derivative remarkably decreases the surface tension of the aqueous solution, thereby preventing pattern collapse.

Preferably, the water of the disclosed cleaning solution is distilled water.

In addition, the disclosed cleaning solution may further comprise an alcohol compound.

The alcohol compound can be selected from C₁-C₃₀ alkyl alcohol, C₁-C₃₀ alkoxy alcohol and mixtures thereof. Preferably, the alkyl alcohol is selected from the group consisting of methanol, ethanol, propanol, iso-propanol, n-butanol, sec-butanol, t-butanol, 1-pentanol, 2-pentanol, 3-pentanol, 2,2-dimethyl-1-propanol, and mixtures thereof, and the alkoxy alcohol is preferably selected from the group consisting of 2-methoxyethanol, 2-(2-methoxyethoxy)ethanol, 1-methoxy-2-propanol, 3-methoxy-1,2-propandiol, and mixtures thereof.

In the cleaning solution for photoresist, the compound of Formula 1 as a surfactant is preferably present in an amount ranging from 0.001 wt % to 5 wt %, preferably from 0.001 wt % to 0.5 wt % based on total weight of the solution, and the alcohol compound is present in an amount ranging from 0 wt % to 10 wt %, preferably from 0.01 wt % to 5 wt % based on total weight of the solution.

When the compound of Formula 1 is less than 0.001 wt %, the effect of decreasing the surface tension becomes decreased. When the compound of Formula 1 is more than 5 wt %, the effect of decreasing the surface tension also becomes decreased and the residual compound of Formula 1 still remains on the surface of the semiconductor substrate.

Additionally, when the amount of added alcohol compound is more than 10 wt %, the alcohol compound may dissolve the photoresist, resulting in the pattern collapse.

The disclosed cleaning solution is preferably prepared by filtering a mixture solution comprising water, the compound of Formula 1, and the alcohol compound with a 0.2 μm filter.

The above-described cleaning solution can be used in processes for forming a photoresist pattern using a developing solution, that is, adapting a wet development process.

In addition, there is provided a method for forming a photoresist pattern using the disclosed cleaning solution. The method comprises the steps of:
(a) coating a photoresist composition on an underlying layer formed on a semiconductor substrate to form a photoresist film;
(b) exposing the photoresist film to a light source;
(c) developing the photoresist film with a developing solution; and
(d) washing the developed photoresist film with the above-described photoresist cleaning solution.

The method may further comprise a soft-baking and/or a post-baking steps before and/or after the step (b). Preferably, the above baking steps are performed at a temperature ranging from 70° C. to 200° C.

Preferably, the above exposing step is performed using the light source for exposure selected from the group consisting of KrF (248 nm), ArF (193 nm), VUV (157 nm), EUV (13 nm), E-beam, X-ray and ion beam, and at an exposure energy ranging from 0.1 mJ/cm² to 50 mJ/cm².

Preferably, the above developing step (c) is performed using an alkali developing solution, of which aqueous tetramethylammoniumhydroxide (TMAH) solution in an amount ranging from 0.01 wt % to 5 wt % is preferred.

As described above, the photoresist film is washed in last step of the development process using the disclosed cleaning solution comprising the compound of Formula 1 as a surfactant. Since the disclosed cleaning solution has relatively low surface tension and affects a contact angle formed between the photoresist and the cleaning solution, it can greatly improve the problems of pattern collapse. The disclosed cleaning solution helps homogeneous interaction between the cleaning solution and the photoresist during the cleaning process, thereby improving LER and CD uniformities.

Additionally, there is provided a semiconductor device fabricated using the above-described method.

### EXAMPLES

Hereinafter, the disclosure method will be described in more detail referring to the examples below, which are not intended to limit the scope of the disclosure.

### Example 1

### Preparation of Disclosed Cleaning Solution (1)

0.1 g of the compound of Formula 1 wherein m is 1, R is nonyl, R′ is H and the weight average molecular weight is 2,000, 0.1 g of the compound of Formula 1 wherein m is 2, R is lauryl, R′ is H and the weight average molecular weight is 2,000, 1 g of methanol and 999 g of water were stirred and mixed for one minute. The resulting mixture was filtered through a 0.2 μm filter to obtain a cleaning solution.

### Example 2

### Preparation of Disclosed Cleaning Solution (2)

0.1 g of the compound of Formula 1 wherein m is 1, R is octyl, R′ is H and the weight average molecular weight is 3,000, 0.1 g of the compound of Formula 1 wherein m is 2, R is lauryl, R′ is H and the weight average molecular weight is 2,000, 1 g of isopropanol and 999 g of water were stirred and mixed for one minute. The resulting mixture was filtered through a 0.2 μm filter to obtain a cleaning solution.

### Example 3

### Preparation of Disclosed Cleaning Solution (3)

0.1 g of the compound of Formula 1 wherein m is 1, R is nonylphenyl, R′ is H and the weight average molecular weight is 3,000, 0.1 g of the compound of Formula 1 wherein m is 2, R is lauryl, R′ is H and the weight average molecular weight is 2,000, 0.1 g of the compound of Formula 1 wherein m is 3, R is lauryl, R′ is H and the weight average molecular weight is 2,000, 1 g of isobutanol and 999 g of water were stirred and mixed for one minute. The resulting mixture was filtered through a 0.2 μm filter to obtain a cleaning solution.

### Example 4

### Preparation of Disclosed Cleaning Solution (4)

0.1 g of the compound of Formula 1 wherein m is 1, R is H, R′ is H and the weight average molecular weight is 10,000, 0.1 g of the compound of Formula 1 wherein m is 1, R is tridecyl, R′ is H and the weight average molecular weight is 3,000, 0.1 g of the compound of Formula 1 wherein m is 3, R is lauryl, R′ is H and the weight average molecular weight is 2,000, 1 g of methanol and 999 g of water were stirred and mixed for one minute. The resulting mixture was filtered through a 0.2 μm filter to obtain a cleaning solution.

### Example 5

### Formation of Photoresist Pattern (1)

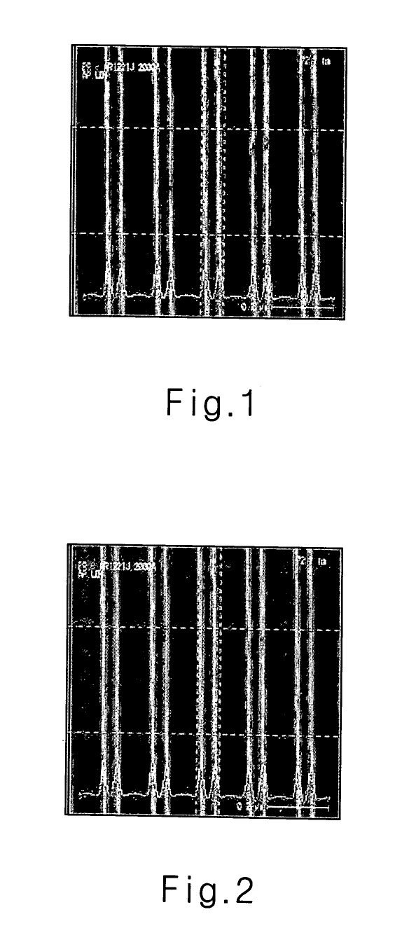

An underlying layer was formed on a silicon wafer treated with hexamethyldisilazane (HMDS), and AR1121J produced by JSR Co., Ltd. as a methacrylate-type photosensitizer was spin-coating on the underlying layer to form a photoresist film at a thickness of 2,000 Å. Then, the photoresist film was soft-baked at 130° C. for 90 seconds. After soft-baking, the photoresist film was exposed to light using an ArF laser exposer, and then post-baked at 130° C. for 90 seconds. After post-baking was completed, the photoresist film was developed in a 2.38 wt. % aqueous TMAH solution for 30 seconds. Next, 30 ml of the cleaning solution obtained from Example 1 was sprayed on the photoresist film from upper portion of a spin device while the silicon wafer was under spinning to wash the silicon wafer. After drying, 71 nm L/S ultrafine photoresist pattern was obtained (see FIG. 1).

### Example 6

### Formation of Photoresist Pattern (2)

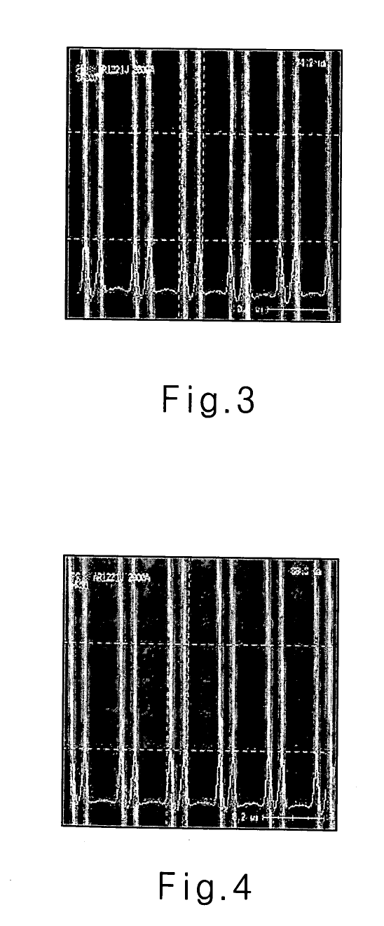

The procedure of Example 1 was repeated using the cleaning solution obtained from Example 2 instead of the cleaning solution obtained from Example 1, thereby obtaining 73 nm L/S ultrafine photoresist pattern (see FIG. 2).

### Example 7

### Formation of Photoresist Patterns (3)

The procedure of Example 1 was repeated using the cleaning solution obtained from Example 3 instead of the cleaning solution obtained from Example 1, thereby obtaining 74 nm L/S ultrafine photoresist pattern (see FIG. 3).

### Example 8

### Formation of Photoresist Pattern (4)

The procedure of Example 1 was repeated using the cleaning solution obtained from Example 4 instead of the cleaning solution obtained from Example 1, thereby obtaining 68 nm L/S ultrafine photoresist pattern (see FIG. 4).

### Comparative Example

### Formation of Photoresist Pattern (5)

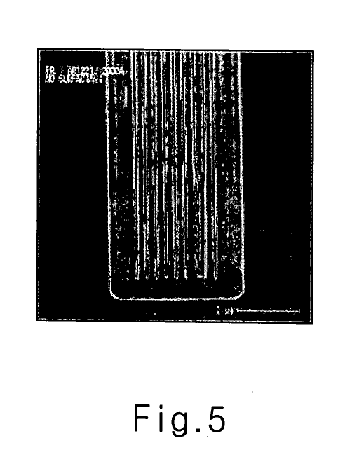

The procedure of Example 1 was repeated using the distilled water instead of the disclosed cleaning solution, thereby obtaining a pattern which was collapsed unlike the patterns obtained from Examples 5 to 8 (see FIG. 5).

As discussed above, the cleaning solution for photoresist comprising a compound of Formula 1, an optional alcohol compound, and water has lower surface tension than that of distilled water used as a conventional cleaning solution. When the disclosed cleaning solution is used to wash a semiconductor substrate in the final process after the developing step for formation of photoresist patterns, pattern collapse is found to decrease remarkably. Accordingly, the disclosed cleaning solution for photoresist can contribute to stabilization of the process for forming an ultrafine photoresist pattern of less than 130 nm.

1. A cleaning solution for photoresist comprising water and a surfactant represented by Formula 1:
R{(OCH₂CH₂)ₗ[O(CH₂)ₘCH₂]ₙ}R′ Formula 1
wherein
R and R′ are independently H, C₁-C₄₀ alkyl or C₁-C₄₀ alkyl aryl;
l and n are independently integers ranging from 1 to 500;
m is an integer ranging from 0 to 10; and
the weight average molecular weight ranges from 100 to 50,000.

2. The cleaning solution according to claim 1, further comprising an alcohol compound.

3. The cleaning solution according to claim 1, wherein said surfactant is present in an amount ranging from 0.001 wt % to 5 wt % based on total weight of the solution, and an optional alcohol compound is present in an amount ranging from 0 wt % to 10 wt % based on total weight of the solution.

4. The cleaning solution according to claim 3, wherein said surfactant is present in an amount ranging from 0.001 to 0.5 wt % based on total weight of the solution, and the alcohol compound is present in an amount ranging from 0.01 to 5 wt % based on total weight of the solution.

5. The cleaning solution according to claim 2, wherein the alcohol compound is selected from the group consisting of C₁-C₃₀ alkyl alcohol, C₁-C₃₀ alkoxy alcohol and mixtures thereof.

6. The cleaning solution according to claim 5, wherein the C₁-C₃₀ alkyl alcohol is selected from the group consisting of methanol, ethanol, propanol, iso-propanol, n-butanol, sec-butanol, t-butanol, 1-pentanol, 2-pentanol, 3-pentanol, 2,2-dimethyl-1-propanol, and mixtures thereof.

7. The cleaning solution according to claim 5, wherein the C₁-C₃₀ alkoxy alcohol is selected from the group consisting of 2-methoxyethanol, 2-(2-methoxyethoxy)ethanol, 1-methoxy-2-propanol, 3-methoxy-1,2-propandiol, and mixtures thereof.

8. The cleaning solution according to claim 2, wherein the cleaning solution is selected from the group consisting of:
a solution comprising said surfactant wherein m is 1, R is nonyl, R′ is H and the weight average molecular weight is 2,000; said surfactant wherein m is 2, R is lauryl, R′ is H and the weight average molecular weight is 2,000; methanol; and distilled water;
a solution comprising said surfactant wherein m is 1, R is octyl, R′ is H and the weight average molecular weight is 3,000; said surfactant wherein m is 2, R is lauryl, R′ is H and the weight average molecular weight is 2,000; isopropanol; and distilled water;
a solution comprising said surfactant wherein m is 1, R is nonyl phenyl, R′ is H and the weight average molecular weight is 3,000; said surfactant wherein m is 2, R is lauryl, R′ is H and the weight average molecular weight is 2,000; said surfactant wherein m is 3, R is lauryl, R′ is H and the weight average molecular weight is 2,000; isobutanol; and distilled water; and
a solution comprising said surfactant wherein m is 1, R is H, R′ is H and the weight average molecular weight is 10,000; said surfactant wherein m is 1, R is tridecyl, R′ is H and the weight average molecular weight is 3,000; said surfactant wherein m is 3, R is lauryl, R′ is H and the weight average molecular weight is 2,000; methanol; and distilled water.

9. The cleaning solution according to claim 1, wherein R and R′ are independently selected from the group consisting of H, octyl, octyl phenyl, nonyl, nonyl phenyl, decyl, decyl phenyl, undecyl, undecyl phenyl, dodecyl, and dodecyl phenyl, and 1 and n are independently integers ranging from 10 to 50.

10. The cleaning solution according to claim 1, wherein said surfactant is present singly or in combination of two or more compounds thereof.

11. The cleaning solution according to claim 1, wherein said surfactant is selected from the group consisting of a compound wherein m is 1, R is nonyl, R′ is H and the weight average molecular weight is 2,000; a compound wherein m is 2, R is lauryl, R′ is H and the weight average molecular weight is 2,000; a compound wherein m is 1, R is octyl, R′ is H and the weight average molecular weight is 3,000; a compound wherein m is 2, R is lauryl, R′ is H and the weight average molecular weight is 2,000; a compound wherein m is 1, R is nonyl phenyl, R′ is H and the weight average molecular weight is 3,000; a compound wherein m is 2, R is lauryl, R′ is H and the weight average molecular weight is 2,000; a compound wherein m is 3, R is lauryl, R′ is H and the weight average molecular weight is 2,000; a compound wherein m is 1, R is H, R′ is H and the weight average molecular weight is 10,000; a compound wherein m is 1, R is tridecyl, R′ is H and the weight average molecular weight is 3,000; and a compound wherein m is 3, R is lauryl, R′ is H and the weight average molecular weight is 2,000.

12. A method for forming a photoresist pattern, comprising the steps of:
(a) coating a photoresist composition on an underlying layer formed on a semiconductor substrate to form a photoresist film;
(b) exposing the photoresist film to a light source;
(c) developing the photoresist film with a developing solution; and
(d) washing the developed photoresist film with the photoresist cleaning solution described in claim 1.

13. The method according to claim 12, further comprising soft-baking before step (b) or post-baking after step (b).

14. The method according to claim 12, wherein the light source is selected from the group consisting of KrF (248 nm), ArF (193 nm), VUV (157 nm), EUV (13 nm), E-beam, X-ray and ion beam.

15. A semiconductor device fabricated using the method described in claim 12.

16. A method for forming a photoresist pattern, comprising the steps of:
(a) coating a photoresist composition on an underlying layer formed on a semiconductor substrate to form a photoresist film;
(b) exposing the photoresist film to a light source;
(c) developing the photoresist film with a developing solution; and
(d) washing the developed photoresist film with the photoresist cleaning solution described in claim 2.

17. The method according to claim 16, further comprising soft-baking before step (b) or post-baking after step (b).

18. The method according to claim 16, wherein the light source is selected from the group consisting of KrF (248 nm), ArF (193 nm), VUV (157 nm), EUV (13 nm), E-beam, X-ray and ion beam.

19. A semiconductor device fabricated using the method described in claim 16.
